(19) United States
(12) Patent Application Publication
(10) Pub. No.: US 2026/0040023 A1
(43) Pub. Date: Feb. 5, 2026

(54) Audio Processing Adaptation

(71) Applicant: NOKIA TECHNOLOGIES OY, Espoo (FI)

(72) Inventors: Toni Makinen, Pirkkala (FI); Mikko Tapio Tammi, Tampere (FI); Riitta Elina Vaananen, Helsinki (FI); Roope Olavi Jarvinen, Lempäälä (FI)

(21) Appl. No.: 18/997,947

(22) PCT Filed: Jul. 4, 2023
(86) PCT No.: PCT/EP2023/068283

§ 371 Date: Jan. 23, 2025

(30) Foreign Application Priority Data
Jul. 28, 2022 (GB) 2211058.9

(51) Int. Cl. H04S 7/00

(52) U.S. Cl. CPC H04S 7/307; H04S 2400/01; H04S 2400/15

(57) ABSTRACT

A method for: obtaining at least one microphone audio signal; obtaining at least one spatial sound environment parameter associated with the at least one microphone audio signal; obtaining at least one monitored control setting, the monitored control setting determined by monitoring a plurality of control settings for an audio application based on monitoring; adjusting at least one audio application tuning parameter based on at least one of: the at least one spatial sound environment parameter; or the at least one monitored control setting; and controlling the audio application based on the at least one audio application tuning parameter, the application including an audio signal processing of the at least one microphone audio signal.

### FIELD

The present application relates to apparatus and methods for audio processing adaptation based on control settings and spatial sound environment analysis but not exclusively based on historical analysis of user control settings and spatial sound environments.

### BACKGROUND

Audio processing is a well known aspect of digital signal processing. A practical application of audio processing is the processing of microphone signal(s) or other suitable input audio signals in order to generate output audio signals for speakers or headphones which can be used to generate audible sounds when played back from the speakers or headphones.

The use of audio processing can thus be employed to modify audio characteristics, such as frequency response, spatial response, gain levels etc, of these input audio signals.

The ability of audio processing to generate a quality audible output is highly dependent on many factors. These factors can include the microphone specification and their locations, the apparatus or device form factor, the sound environment within which the capture apparatus is located, and of course a user preference or preferred user experience.

In order to process audio in a way that is wanted and required for a specific use case with a specific audio device, the audio processing method can be modified or tuned. The modification or tuning of an audio processing method practically can be the setting of processing parameters of the processing methods or algorithms. Example processing parameters can be parameters such as frequency band limits, gain values, microphone distances.

The setting of processing parameters, such that the perceived audio experience is satisfactory, regardless of the sound environment, user control settings, or any other such aspects is an issue into which much inventive effort has been applied.

### SUMMARY

There is provided according to a first aspect a method for: obtaining at least one microphone audio signal; obtaining at least one spatial sound environment parameter associated with the at least one microphone audio signal; obtaining at least one monitored control setting, the monitored control setting determined by monitoring a plurality of control settings for an audio application based on monitoring; adjusting at least one audio application tuning parameter based on at least one of: the at least one spatial sound environment parameter; or the at least one monitored control setting; and controlling the audio application based on the at least one audio application tuning parameter, the application comprising an audio signal processing of the at least one microphone audio signal.

Obtaining at least one microphone audio signal may further comprise obtaining at least two microphone audio signals and obtaining at least one spatial sound environment parameter associated with the at least one microphone audio signal may comprise analysing the at least two microphone audio signals to determine the at least one spatial sound environment parameter.

The at least one spatial sound environment parameter may comprise at least one of: an environment spatial classification associated with the at least one microphone audio signal, the classification identifying a type of environment within which the at least one microphone audio signal is captured; a determined number of sound sources associated with the at least one microphone audio signal; at least one sound source direction with respect to the apparatus sources associated with the at least one microphone audio signal; at least one sound source location associated with the at least one microphone audio signal; at least one sound source position associated with the at least one microphone audio signal; a frequency response of at least one sound source associated with the at least one microphone audio signal; or a classification of at least one sound source associated with the at least one microphone audio signal.

Obtaining at least one monitored control setting may comprise monitoring at least one desired control parameter value for the audio application.

Controlling the audio application based on the at least one audio application tuning parameter may comprise controlling at least one audio application tuning parameter limit.

Adjusting at least one audio application tuning parameter based on at least one of: the at least one spatial sound environment parameter; or the at least one monitored control setting may comprise: storing the at least one of: the at least one spatial sound environment parameter; or the at least one monitored control setting for a defined analysis period; and determining the at least one audio application tuning parameter limit based on at least one of: the at least one spatial sound environment parameter; or the at least one monitored control setting, over the defined analysis period.

Determining the at least one audio application tuning parameter limit based on at least one of: the at least one spatial sound environment parameter; or the at least one monitored control setting, over the defined analysis period may comprise: increasing the at least one audio application tuning parameter limit maximum value when the at least one monitored control setting over the defined analysis period is greater than a threshold value for more than a defined portion of the defined analysis period; decreasing the at least one audio application tuning parameter limit maximum value when the at least one monitored control setting over the defined analysis period is less than the threshold value for more than a defined portion of the defined analysis period; and maintaining the at least one audio application tuning parameter limit maximum value otherwise.

The at least one audio application tuning parameter limit may comprise at least one of: a processing control parameter range; a processing control parameter value maximum; and a processing control parameter value minimum.

According to a second aspect there is provided an apparatus comprising means configured to: obtain at least one microphone audio signal; obtain at least one spatial sound environment parameter associated with the at least one microphone audio signal; obtain at least one monitored control setting, the monitored control setting determined by monitoring a plurality of control settings for an audio application based on monitoring; adjust at least one audio application tuning parameter based on at least one of: the at least one spatial sound environment parameter; or the at least one monitored control setting; and control the audio application based on the at least one audio application tuning parameter, the application comprising an audio signal processing of the at least one microphone audio signal.

The means configured to obtain at least one microphone audio signal may be further configured to obtain at least two microphone audio signals and the means configured to obtain at least one spatial sound environment parameter associated with the at least one microphone audio signal may be configured to analyse the at least two microphone audio signals to determine the at least one spatial sound environment parameter.

The at least one spatial sound environment parameter may comprise at least one of: an environment spatial classification associated with the at least one microphone audio signal, the classification identifying a type of environment within which the at least one microphone audio signal is captured; a determined number of sound sources associated with the at least one microphone audio signal; at least one sound source direction with respect to the apparatus sources associated with the at least one microphone audio signal; at least one sound source location associated with the at least one microphone audio signal; at least one sound source position associated with the at least one microphone audio signal; a frequency response of at least one sound source associated with the at least one microphone audio signal; or a classification of at least one sound source associated with the at least one microphone audio signal.

The means configured to obtain at least one monitored control setting may be configured to monitor least one desired control parameter value for the audio application.

The means configured to control the audio application based on the at least one audio application tuning parameter may be configured to control at least one audio application tuning parameter limit.

The means configured to adjust at least one audio application tuning parameter based on at least one of: the at least one spatial sound environment parameter; or the at least one monitored control setting may be configured to: store the at least one of: the at least one spatial sound environment parameter; or the at least one monitored control setting for a defined analysis period; and determine the at least one audio application tuning parameter limit based on at least one of: the at least one spatial sound environment parameter; or the at least one monitored control setting, over the defined analysis period.

The means configured to determine the at least one audio application tuning parameter limit based on at least one of: the at least one spatial sound environment parameter; or the at least one monitored control setting, over the defined analysis period may be configured to: increase the at least one audio application tuning parameter limit maximum value when the at least one monitored control setting over the defined analysis period is greater than a threshold value for more than a defined portion of the defined analysis period; decrease the at least one audio application tuning parameter limit maximum value when the at least one monitored control setting over the defined analysis period is less than the threshold value for more than a defined portion of the defined analysis period; and maintain the at least one audio application tuning parameter limit maximum value otherwise.

The at least one audio application tuning parameter limit may comprise at least one of: a processing control parameter range; a processing control parameter value maximum; and a processing control parameter value minimum.

According to a third aspect there is provided an apparatus comprising: at least one processor and at least one memory storing instructions that when executed by the at least one processor cause the apparatus at least to: obtain at least one microphone audio signal; obtain at least one spatial sound environment parameter associated with the at least one microphone audio signal; obtain at least one monitored control setting, the monitored control setting determined by monitoring a plurality of control settings for an audio application based on monitoring; adjust at least one audio application tuning parameter based on at least one of: the at least one spatial sound environment parameter; or the at least one monitored control setting; and control the audio application based on the at least one audio application tuning parameter, the application comprising an audio signal processing of the at least one microphone audio signal.

The apparatus caused to obtain at least one microphone audio signal may further be cased to obtain at least two microphone audio signals and the apparatus caused to obtain at least one spatial sound environment parameter associated with the at least one microphone audio signal may be caused to analyse the at least two microphone audio signals to determine the at least one spatial sound environment parameter.

The at least one spatial sound environment parameter may comprise at least one of: an environment spatial classification associated with the at least one microphone audio signal, the classification identifying a type of environment within which the at least one microphone audio signal is captured; a determined number of sound sources associated with the at least one microphone audio signal; at least one sound source direction with respect to the apparatus sources associated with the at least one microphone audio signal; at least one sound source location associated with the at least one microphone audio signal; at least one sound source position associated with the at least one microphone audio signal; a frequency response of at least one sound source associated with the at least one microphone audio signal; or a classification of at least one sound source associated with the at least one microphone audio signal.

The apparatus caused to obtain at least one monitored control setting may be caused to monitor at least one desired control parameter value for the audio application.

The apparatus caused to control the audio application based on the at least one audio application tuning parameter may be caused to control at least one audio application tuning parameter limit.

The apparatus caused to adjust at least one audio application tuning parameter based on at least one of: the at least one spatial sound environment parameter; or the at least one monitored control setting may be caused to: store the at least one of: the at least one spatial sound environment parameter; or the at least one monitored control setting for a defined analysis period; and determine the at least one audio application tuning parameter limit based on at least one of: the at least one spatial sound environment parameter; or the at least one monitored control setting, over the defined analysis period.

The apparatus caused to determine the at least one audio application tuning parameter limit based on at least one of: the at least one spatial sound environment parameter; or the at least one monitored control setting, over the defined analysis period may be caused to: increase the at least one audio application tuning parameter limit maximum value when the at least one monitored control setting over the defined analysis period is greater than a threshold value for more than a defined portion of the defined analysis period; decrease the at least one audio application tuning parameter limit maximum value when the at least one monitored control setting over the defined analysis period is less than the threshold value for more than a defined portion of the defined analysis period; and maintain the at least one audio application tuning parameter limit maximum value otherwise.

The at least one audio application tuning parameter limit may comprise at least one of: a processing control parameter range; a processing control parameter value maximum; and a processing control parameter value minimum.

According to a fourth aspect there is provided an apparatus comprising: an audio signal obtainer configured to obtain at least one microphone audio signal; an environment parameter obtainer configured to obtain at least one spatial sound environment parameter associated with the at least one microphone audio signal; a control setting determiner configured to obtain at least one monitored control setting, the monitored control setting determined by monitoring a plurality of control settings for an audio application based on monitoring; a tuning parameter adjuster configured to adjust at least one audio application tuning parameter based on at least one of: the at least one spatial sound environment parameter; or the at least one monitored control setting; and an application controller configured to control the audio application based on the at least one audio application tuning parameter, the application comprising an audio signal processing of the at least one microphone audio signal.

According to a fifth aspect there is provided an apparatus comprising: obtaining circuitry configured to obtain at least one microphone audio signal; an obtaining circuitry configured to obtain at least one spatial sound environment parameter associated with the at least one microphone audio signal; obtaining circuitry configured to obtain at least one monitored control setting, the monitored control setting determined by monitoring a plurality of control settings for an audio application based on monitoring; tuning parameter adjusting circuitry configured to adjust at least one audio application tuning parameter based on at least one of: the at least one spatial sound environment parameter; or the at least one monitored control setting; and application controlling circuitry configured to control the audio application based on the at least one audio application tuning parameter, the application comprising an audio signal processing of the at least one microphone audio signal.

According to a sixth aspect there is provided a computer program comprising instructions [or a computer readable medium comprising program instructions] for causing an apparatus to perform at least the following: obtaining at least one microphone audio signal; obtaining at least one spatial sound environment parameter associated with the at least one microphone audio signal; obtaining at least one monitored control setting, the monitored control setting determined by monitoring a plurality of control settings for an audio application based on monitoring; adjusting at least one audio application tuning parameter based on at least one of: the at least one spatial sound environment parameter; or the at least one monitored control setting; and controlling the audio application based on the at least one audio application tuning parameter, the application comprising an audio signal processing of the at least one microphone audio signal.

According to a seventh aspect there is provided a non-transitory computer readable medium comprising program instructions for causing an apparatus to perform at least the following: obtaining at least one microphone audio signal; obtaining at least one spatial sound environment parameter associated with the at least one microphone audio signal; obtaining at least one monitored control setting, the monitored control setting determined by monitoring a plurality of control settings for an audio application based on monitoring; adjusting at least one audio application tuning parameter based on at least one of: the at least one spatial sound environment parameter; or the at least one monitored control setting; and controlling the audio application based on the at least one audio application tuning parameter, the application comprising an audio signal processing of the at least one microphone audio signal.

According to an eighth aspect there is provided an apparatus comprising: means for obtaining at least one microphone audio signal; means for obtaining at least one spatial sound environment parameter associated with the at least one microphone audio signal; means for obtaining at least one monitored control setting, the monitored control setting determined by monitoring a plurality of control settings for an audio application based on monitoring; means for adjusting at least one audio application tuning parameter based on at least one of: the at least one spatial sound environment parameter; or the at least one monitored control setting; and means for controlling the audio application based on the at least one audio application tuning parameter, the application comprising an audio signal processing of the at least one microphone audio signal.

According to a ninth aspect there is provided a computer readable medium comprising program instructions for causing an apparatus to perform at least the following: obtaining at least one microphone audio signal; obtaining at least one spatial sound environment parameter associated with the at least one microphone audio signal; obtaining at least one monitored control setting, the monitored control setting determined by monitoring a plurality of control settings for an audio application based on monitoring; adjusting at least one audio application tuning parameter based on at least one of: the at least one spatial sound environment parameter; or the at least one monitored control setting; and controlling the audio application based on the at least one audio application tuning parameter, the application comprising an audio signal processing of the at least one microphone audio signal.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1a shows schematically an example apparatus suitable for implementing some embodiments;

FIG. 1b shows a flow diagram of the operation of the example apparatus as shown in FIG. 1a;

FIG. 2 shows schematically an example updater/storage 109 as shown in FIG. 1a;

FIG. 3a shows a flow diagram of the operation of the example apparatus shown in FIG. 1a according to some embodiments;

FIG. 3b shows a further flow diagram of the operation of the example apparatus shown in FIG. 1a according to some embodiments;

FIG. 4 shows an example graph of adjustments to zoom gain parameters to output audio signals in an example operation some embodiments; and

FIG. 5 shows a further example graph of adjustments to zoom gain parameters to output audio signals in an example operation some embodiments.

### EMBODIMENTS OF THE APPLICATION

The following describes in further detail suitable apparatus and possible mechanisms for audio processing adjustment based on historical analysis of user controls and spatial sound environments.

As described above optimisation of audio signal processing and the setting of the processing parameters to produce a good quality output audio signal able to produce an audible signal from the loudspeaker or headphones or any suitable output transducer is a known issue. Typically audio signal processing parameters are set by the device manufacturer, and because the setting and adjustment of these processing parameters require detailed knowledge and expertise of the corresponding processing algorithms, these parameters are fixed by the device manufacturer and cannot be modified later by the user.

The problem with employing a fixed parameter audio processing algorithm that a “perfect tuning” (or perfect parameter selection) is often very hard to find. Thus typically for fixed parameter selection compromises are accepted to prevent unwanted behaviour in audio capture/playback. The fixed parameter audio processing (or set tuning) is always a compromise between achieving an acceptable algorithm performance and not causing unwanted artefacts in the output audio signal. For example there can be a first set of parameter settings which would produce a good quality output in 80% of the situations in which the apparatus or device experiences, an acceptable quality output in 15% but in the remainder the output is very poor with significant audio artifacts in the output. There can also be a second set of parameter settings which would produce a good quality output in 5% of the situations in which the apparatus or device experiences, and acceptable quality output in 95%. Although based on the above probabilities the first set of parameters would produce a better quality output these settings would not be selected by the device manufacturer because the 5% of the situations where the output signals are very poor would lead the user to believe the device is faulty.

It is hence easy to understand that having to compromise the tuning such that it never deteriorates the signal, prevents the device from achieving the highest potential of the audio processing algorithms in general and therefore leads to a sub-optimal result.

Additionally, as well as the device or apparatus situation changes the user preferences can differ significantly, meaning that a single fixed tuning solution (a fixed set of audio signal processing parameters) will not be optimal for every user.

The compromises in audio processing thus will generally limit the performance of audio features of a specific device or apparatus. For example an audio zooming operation is either not as effective as it could be or it processes the audio too aggressively, a noise cancellation operation either cannot remove the noise as effectively as it could or it processes the audio too aggressively, an audio source tracking operation either cannot find or track all the sources effectively or it finds too many sources.

Together these limitations create a poorer user experience, and thus the user will not employ the algorithms as much as they would be if their performance was better.

This is an issue for audio processing algorithm developers and manufacturers business-wise, and more importantly, causes poorer audio experiences for end-users and slows down the adaptation of potential new audio technologies among the end-users.

It is known that some smart audio speakers are configured to adapt to their location and provide an enhanced listening experience by taking into account the room shape and furniture within the room. However, they typically only perform a single calibration for each location during a device initialization or deployment and it does not take into account possible furniture changes or other modifications implemented in the room. Thus, the system is not adaptive in nature, but keeps its calibrated settings fixed until it is moved again to a new location.

The concept as employed in the following examples and embodiments is one where a continuous learning over time is implemented. The continuous learning is configured to adaptively modify the audio algorithm (processing) parameters and improve the performance of the audio processing.

Additionally in some embodiments the learning process employs spatial audio content analysis and detailed user behaviour analysis based on user control settings over time.

Thus, the embodiments as discussed in further detail herein introduce adaptive tuning for audio processing, where the audio processing parameters can be automatically tuned over time. This adaptation can be based on a learning process, where both the history of a specific algorithm user control settings and the history of the algorithm/device spatial sound environments is determined, tracked and analysed. The aim of such embodiments is to learn the typical user control settings preferred by the user and the typical sound environments in which the algorithm is being implemented.

Thus in summary the embodiments are configured to:
determine and/or track user preferences, such as typical user control settings of at least one audio processing algorithm;
analyze and/or track spatial sound environments (in the sense of sound sources, their directions, audio content, ambience level etc.) where the at least one audio processing algorithm is used;
whenever feasible, modify at least one adjustable or tuneable parameter of the at least one audio processing algorithm; and
set a new scale (for example a minimum and maximum parameter value) for the tuning parameters according to, e.g., user behaviour history or environment analysis.

Thus the learning process, as implemented in some embodiments, allows more aggressive gain parameters values to be applied with audio zooming or more aggressive noise removal when preferred by the user and/or is feasible in the sound environment.

The apparatus and methods can be configured, as described in the embodiments herein, to enable the algorithm parameters to be constantly updated over time based on the learned user behaviour and environment, to ensure optimal algorithm performance in the sense of user preferences and typical sound environments. This increases the satisfaction of the end-user towards the audio algorithms, as their full potential can be taken into use in practice.

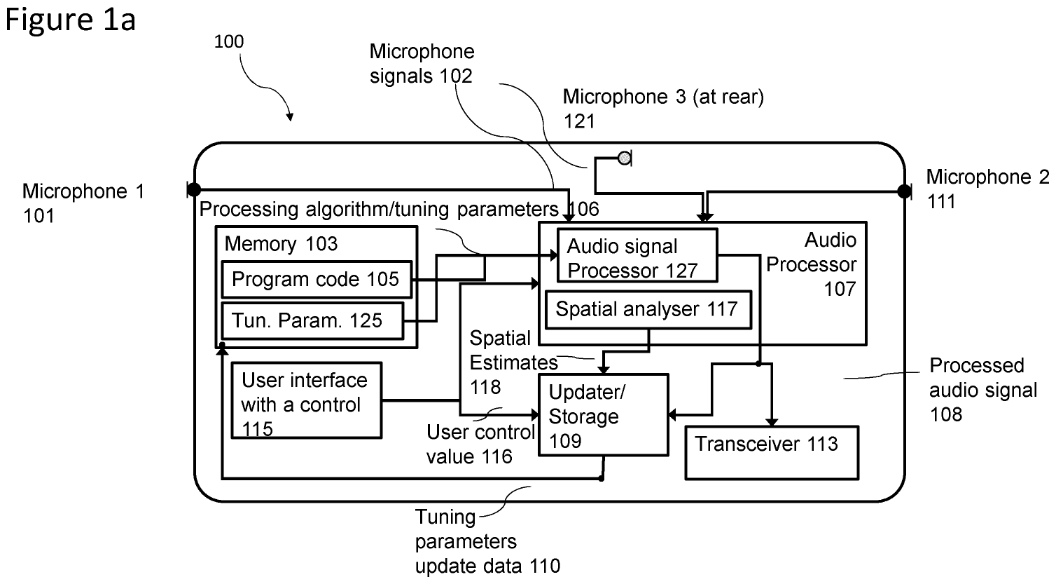

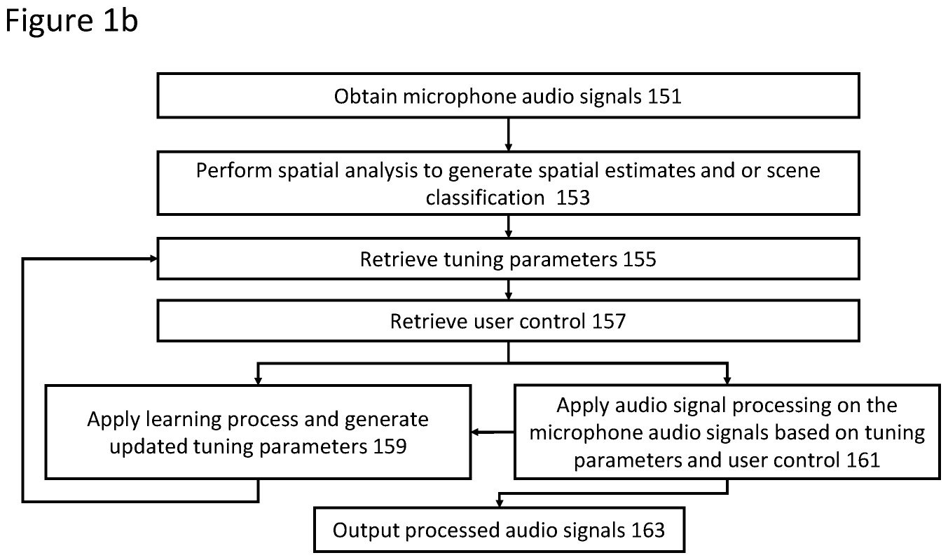

An example of a suitable apparatus or electronic device for implementing some embodiments is shown in FIG. 1a. The example electronic device or apparatus can be or be part of any suitable apparatus such as described herein. For example, in some embodiments the electronic device 100 is a mobile device, user equipment, tablet computer, computer, audio playback apparatus, etc. The device may be configured to implement any functional block as described herein.

In some embodiments the apparatus 100 comprises (at least one) audio processor 107 (which can be implemented as a central processing unit or any suitable processing component or element). The audio processor 107 can be configured to execute various audio processing program codes, such as the functions spatial analyser 117 and/or audio signal processor 127 as described herein.

In some embodiments the apparatus 100 further comprises at least one memory 103. In some embodiments the at least one audio processor 107 is coupled to the memory 103. The memory 103 can be any suitable storage means. In some embodiments the memory 103 comprises a program code section 105, for storing program codes. For example, in some embodiments, the program code section 105 is configured to store program code implementable upon the audio processor 107. Furthermore, in some embodiments the memory 103 can further comprise a stored data section for storing data, for example a tuning parameter 125 which is configured to store tuning parameter data. In some embodiments the stored data section can further be configured to store data that has been processed or to be processed in accordance with the embodiments as described herein. The implemented program code stored within the program code section and the data 106 stored within the stored data section can be retrieved by the audio processor 107 whenever needed via a suitable memory-processor coupling.

In some embodiments the apparatus 100 comprises a user interface 115. The user interface 115 can be coupled in some embodiments to the processor 107. In some embodiments the processor 107 can be configured to receive from the user interface 115 user control values 116.

In some embodiments the apparatus 100 comprises a transceiver 113. The transceiver 113 in such embodiments can be coupled to the processor 107 and configured to receive processed audio signals 108 and enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver 113 can be configured to communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

In some embodiments the apparatus 100 comprises an updater/storage 109. The updater/storage 109 in some embodiments is coupled to the audio processor 107 and is configured to receive spatial estimates 118 and processed audio signals 108. Additionally the updater/storage 109 is configured to be coupled to the user interface 115 and obtain user control values 116. The updater/storage 109 can furthermore be configured to generate or determine updated tuning parameters. The updater/storage 109 can furthermore be configured to be coupled to the memory 103 and is configured to supply to the memory 103 tuning parameters update data 110.

The apparatus 100 furthermore comprises at least one microphone. In the example shown in FIG. 1a there is shown 3 microphones. A microphone 1 101 and microphone 2 111 which are mounted on the ‘front’ of the apparatus at opposite ends of a long axis of the apparatus (in order to provide a large microphone separation distance to assist the spatial analysis) and a microphone 3 121 which is mounted on the ‘rear’ of the apparatus. The microphones are configured to pass microphone signals 102 to the audio processor 107. Although in some embodiments the apparatus can comprise a single microphone, in embodiments such as described herein where spatial environment analysis is implemented by analysis of the microphone audio signals, multiple microphones are required. Thus, in some embodiments, where the spatial environment analysis is implemented by another means (for example via camera image analysis or user input) a single microphone audio signal can be employed.

As described above the audio processor 107 can be configured to implement a spatial analyser 117 function. The spatial analyser 117 is configured to receive the microphone audio signals 102 and analyse the microphone audio signals and determine a class estimate with respect to the microphone audio signals. The audio classifier can implement any suitable classification method, for example as described in GB application 2208716.7. Furthermore classification methods such as described in Yamashita, Rikiya et al. “Convolutional neural networks: an overview and application in radiology.” Insights into imaging vol. 9,4 (2018): 611-629 may be implemented.

Additionally in some embodiments the spatial analyser 117 is configured to implement spatial audio source tracking. The spatial audio source tracking algorithm can be any suitable audio source determination and tracking method, for example such as described in Wu, K., Khong, A. W. H. (2016). Sound Source Localization and Tracking. In: Magnenat-Thalmann, N., Yuan, J., Thalmann, D., You, BJ. (eds) Context Aware Human-Robot and Human-Agent Interaction. Human-Computer Interaction Series. Springer, Cham. https://doi.org/10.1007/978-3-319-19947-4_3.

These spatial estimates and/or classifications 118 generated by the spatial analyser 117 can be configured to be passed to the updater/storage 109.

In other words, the spatial analyser 117 is configured to provide a corresponding audio class estimate and sound source estimates. For example the spatial analyser 117 can be configured to obtain or determine or track the number/direction/location/content of the found sound sources and also determine the audio ambience conditions.

Additionally in some embodiments the audio processor 107 and the audio signal processor 127 is configured to receive the microphone audio signals 102 from the microphones 101, 111, 121 and also the tuning parameters 106 from the memory 103. The audio signal processor 127 is thus configured to implement audio signal processing on the microphone audio signals 102 based on the tuning parameters 106.

To adaptively tune a specific algorithm (which is shown in these embodiments as audio signal processing algorithms which may be located in the program code stored in the system memory 103 and implemented as the audio signal processor 127 within the audio processor 107), the algorithm can be configured to obtain and modify the audio signal processing based on tuneable parameters 106 (which in some embodiments comprise a default and limit values). The audio signal processor 127 can then process the microphone signals 102 using the audio signal processing method and based on the tuning parameters 106 and user control values 116 (provided from the user interface 115).

In some embodiments the spatial estimates and/or determined spatial class estimates 118 can be passed to the updater/storage 109. The spatial estimates and/or determined spatial class estimates 118 can be stored and further analysed in order to determine an updated tuning parameter(s). These updated tuning parameters can then be stored (for example in the memory 103) and then further used by the audio signal processor 127. In other words the updated tuning parameters (data) can be fed-back to the audio signal processing algorithms so to update the tuning parameters used by the audio signal processor to process the audio signals from the microphones accordingly.

With respect to FIG. 1b is shown an example flow diagram showing the operations of the apparatus as shown in FIG. 1a with respect to some embodiments.

Thus in some embodiments the method comprises the operation of obtaining the microphone audio signals as shown in FIG. 1b by step 151.

Then spatial analysis is performed on the microphone audio signals to generate spatial estimates and/or spatial class estimates (such as scene classification, determine the number of sources, the orientation or location of the sources, level of ambience etc.) as shown in FIG. 1b by step 153.

Additionally the (updated) tuning parameters are retrieved or otherwise obtained as shown in FIG. 1b by step 155.

Furthermore the user control is obtained or otherwise retrieved as shown in FIG. 1b by step 157.

Audio signal processing is applied to the microphone audio signals based on the tuning parameters and user control as shown in FIG. 1b by step 161.

Also then having obtained the user control, tuning parameters and the spatial estimates, a set of updated tuning parameters can be determined as shown in FIG. 1b by step 159. These updated tuning parameters can then be obtained or retrieved as the tuning parameters shown by the loop back to the step 155.

The processed audio signals can then be output as shown in FIG. 1b by step 163.

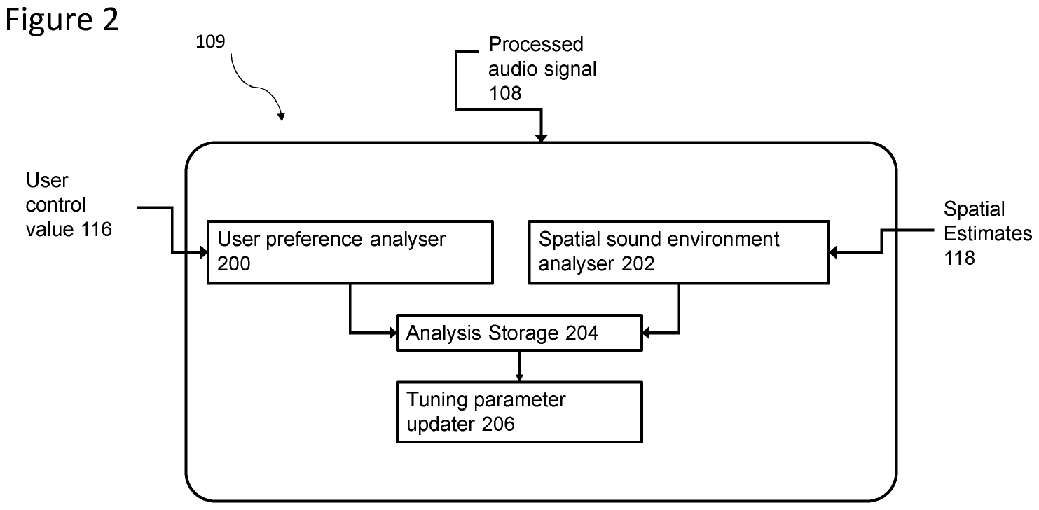

As shown in FIG. 2 an example updater/storage 109 is shown in further detail. The updater/storage 109 is configured to implement a learning process where any audio signal processing tuning parameters are adaptively adjusted based on user-specific behaviour and obtained sound environment characteristics over time.

In other words the updater/storage 109 is configured to identify (typical) ways of how and where the user is using the device and the audio signal processing algorithms. As these can change over time, user behaviour is determined and tracked (regularly) such that the latest learning results can be used to adaptively modify the tuning parameters and thus adaptively adjust the audio signal processing operations.

In some embodiments the updater/storage 109 comprises a user preference analyser 200 configured to implement user preferences analysis on the received/obtained user control values 116.

Furthermore in some embodiments the updater/storage 109 comprises a spatial sound environment analyser 202 configured to apply spatial sound environment analysis to the spatial estimates.

The updater/storage 109 in some embodiments further comprises analysis storage 204 configured to obtain the output of the user preference analyser 200 and the spatial sound environment analyser 202. In some embodiments the analysis storage is configured to save the output of the analysers as a log file. In some embodiments the analysis storage 204 can be implemented within the memory.

The updater/storage 109 further comprises a tuning parameter updater 206 configured to analyse the stored analysis estimates and parameters and analyse these values over time to learn (typical) user control settings and (typical) sound environments where the device is being used.

A suitable time window for the learning analysis can be used for the analysis. For example a time window (e.g. 1 week or 1 month) can be set to define for how long user behaviour and sound environments are tracked.

In some embodiments the tuning parameter updater 206 is configured to identify regularly repeated user control settings and sound environments (i.e. learn which user control settings and/or sound environments are commonly experienced or determined) within the time window to set the most suitable algorithm tuning parameters for the apparatus/user.

In some embodiments when the apparatus or device is used for the first time, the learning process-based parameter modification can start from a default (factory) setting. These default settings can be used as an anchor point and returned to whenever needed.

The analysers 200, 202 of the learning process can be applied at different parts of the overall audio processing chain. For example, in some embodiments, the analysers can implement analysis whenever the tuneable algorithms are being used. For example analysis can be performed during audio capture. However, where the audio signal processing is a playback audio algorithm, the analysers 200, 202 can be employed during the audio signal playback.

Furthermore in some embodiments the spatial sound environment analyser 202 could be employed as a background process as well as during audio signal processing.

The user preference analyser 200 as described above is configured to receive user control values 116 (or user preferences) and analyse the user preferences considering the behaviour of a specific audio signal processing algorithm (for example this can be an analysis tracking of the user control settings related to that algorithm).

In the following example the audio signal processing is an audio zooming process. However the audio signal processing can, in some embodiments, be any suitable audio signal processing method.

An audio zooming algorithm such as introduced in TWO STAGE AUDIO FOCUS FOR SPATIAL AUDIO PROCESSING, Mikko Tammi, Toni Mäkinen, Jussi Virolainen, Mikko Heikkinen, such as specified in US patent U.S. Pat. No. 10,785,589 features a zoom gain control which specifies a maximal gain value. The user preference analyser 200 in some embodiments is configured to monitor how often (over the analysis period) the gain level set by the user is over a threshold value which can be defined in relation to the maximal gain value. For example in some embodiments the analyser is configured to determine the frequency of the event when the user set zoom gain control value is over 80% (4/5) of the maximal gain level.

This analysis result can then be passed to the analysis storage 204 and further to the tuning parameter updater 206.

In some embodiments the tuning parameter updater 206 is configured to adjust a tuning parameter value based on the output of the analyser 200 (and the analysis storage 204).

For example for the zoom focus tuning parameter from the example provided above the tuning parameter updater 206 can be configured to increase a maximum gain where the frequency of the user control setting value (the zoom gain value set by the user) is greater than the threshold value (4/5 the maximal gain value) for more than a higher defined frequency (90%) of the analysis period.

Furthermore the tuning parameter updater 206 can be configured to maintain a maximum gain where the frequency of the user control setting value (the zoom gain value set by the user) is greater than the threshold value (4/5 the maximal gain value) for less than the higher defined frequency (90%) of the analysis period but more than a lower defined frequency (10%) of the analysis period.

Additionally the tuning parameter updater 206 can be configured to decrease a maximum gain where the frequency of the user control setting value (the zoom gain value set by the user) is greater than the threshold value (4/5 the maximal gain value) for less than the lower defined frequency (10%) of the analysis period.

For example the following table shows an example of how to update a specific maximal gain value.

| No. of times | No. of times | |
|---|---|---|
| gain ≥ 4/5 | gain < 4/5 | Action |
| 90% | 10% | Increase max gain |
| 60% | 40% | Keep max gain as is |
| 10% | 90% | Decrease max gain |

Thus as shown by the first line of the table, if the user most of the time (e.g. 90% of the analysis time period) sets an audio zoom algorithm to its maximum gain level, the maximal allowed zooming gain could be automatically increased over time by modifying the corresponding tuning parameters. This is justified by the assumption that even more gain would be preferred by the user based on their behaviour. However, if the user at some point starts to use audio zooming mainly with milder gain settings, the gain tuning parameters could be decreased again to match with the new user behaviour. This way the algorithm reacts to the user preferences over time by learning their common user settings. Similar adaptation over time can be naturally applied to other types of audio (or non-audio) algorithms having any sort of trackable user control, such as noise cancellation or source tracking.

Although this example shows a strict step control of the maximal gain value (or tuning parameter) it would be understood that the updater can apply interpolated gain adaptability based on the frequency of the event. Additionally the tuning parameter update is shown being based on a single ‘event’ occurrence, whether or not the user preference zoom gain value is greater than a single threshold value (relative to the maximal zoom gain) but in some embodiments, for a single parameter, there is monitored the frequency of multiple events (for example whether the zoom gain lies in the range <1/5, 1/5-2/5, 2/5-3/5, 3/5-4/5, or >4/5) and then determine an adaptive tuning of the signal processing parameter or parameters based on these frequencies.

In some embodiments a statistical analysis of the zoom gain value (or relevant tuning parameter) is determined over the analysis period, for example average gain, mean gain, mode gain, gain variance or standard deviation and the tuning parameter updater is configured to operate relative to the statistical analysis.

The spatial sound environment analyser 202 as described above is configured to receive spatial estimates 118 and analyse the sound environment and its spatial characteristics around the apparatus or device. As described above the term spatial characteristics can refer to the characteristics or parameters associated with sound sources around the apparatus. For example these parameters can be: the number of sources, directions of sources, positions or locations of sources, a content of the sources, and frequency responses associated with the sources. In addition in some embodiments the ambience sound level with respect to direct sound source level (or the ratio of the audio or sound energy of the sources relative ambient sound) can be considered.

The spatial sound environment analyser 202 in some embodiments is configured to analyse the result of an audio classifier (such as described above and further described in GB application 2208716.7. Furthermore classification methods such as described in Yamashita, Rikiya et al. “Convolutional neural networks: an overview and application in radiology.” Insights into imaging vol. 9,4 (2018): 611-629 may be implemented.

The analyser 202 can monitor or track the sound environment history (either constantly or during the usage of a specific audio algorithm such as audio zoom or noise cancellation) and which could reveal typical use case scenarios preferred by the user.

In some embodiments the spatial characteristics can be analyzed using spatial sound source tracking such as described above by Wu, K., Khong, A. W. H. (2016) to substantially instantly react to the current sound environment.

In some embodiments each determined or found sound source can be separated as an individual sound object for further analysis. For example by using audio zooming each sound object can be isolated for further analysis. Hence, each sound source can be individually classified (with an audio classifier) and spectrograms can be computed to estimate their content and frequency responses individually.

The spatial sound environment analyser 202 can be configured in some embodiments, to consider the spatial characteristics, both for immediate and longer-term modifications.

For example, where the audio signal processing is an audio zooming algorithm, the tuning parameters for the audio zooming could be tuned to attenuate non-zoomed sound sources by a significant amount in a situation where there are only a few (or less than a determined threshold number of sound sources, such as 1-2) sound sources with limited amount of ambient background noise.

In some embodiments the tuning parameter updater is configured to implement a tuning of the audio signal parameters based on the output of the spatial sound environment analyser 202. Thus, for example, where the environmental content analysis determines that the audio signals are captured from a specific environment (for example in a traffic sound environment which is filled with car noises, ambient background noise etc.), then the parameters can be tuned based on the determined environment (for example to apply a milder zooming gain, as artefacts are more likely to occur due to the more challenging sound environment). Hence in this traffic sound environment-audio zoom example, audio zoom algorithm parameters controlling the gain difference between zoomed and non-zoomed sound sources could be modified based on the source tracking algorithm analysis and content classification together.

In some embodiments the spatial sound environment analyser 202 and the tuning parameter updater 206 is configured to implement a tuning operation of the audio signal processing based on historical analysis of the spatial sound environment. For example where the sound environment history over time indicates that the apparatus is being used mainly inside a car as a hands-free phone, the tuning parameters such as the noise cancellation algorithm parameters can be adjusted over time (gradually tuned) to a more aggressive noise cancellation mode. In addition, by monitoring the frequency response of the captured audio signals over time this analysis could reveal car-specific tyre noise frequencies or some other vehicle related noise frequency. These identified spatial sound environment frequencies can be used such that the audio signal processing frequency equalization curve can be tuned by modifying the equalization parameters accordingly over time to filter out such constant noise frequencies.

The processed at least one microphone audio signal can furthermore be reproduced (playback) from at least one loudspeaker (where the at least loudspeaker can be the same device's loudspeaker or external to the device, for example external loudspeakers, headphones etc.

In such a manner the apparatus audio performance can be improved by learning its typical use case environment.

In another example, if audio zooming is mainly being used when there is constant music and possibly some speech in the sound environment, then the spatial sound environment analyser 202 and tuning parameter updater 206 can be configured to identify that the user prefers recording concerts and trying to emphasize the music parts of the recordings. Hence, in such circumstances the tuning parameter updater 206 can be configured to tune the parameters of the audio zoom algorithm to a (somewhat) milder level for the user over time, to ensure as high music recording quality as possible and to minimize any artefacts.

In some embodiments the tuning parameter updater 206 is configured to use the audio classifier data to ‘learn’ content-dependent algorithm tuning sets, specifically tuned for the environments where the algorithms are being commonly used by the user.

For example, in some embodiments, where the tuning parameter updater 206 identifies the classifier data over time indicates that the user is commonly inside a car and is configured to tune the parameters controlling noise cancellation and frequency equalization algorithms to be adaptively modified such that they match the specific car. These tunings can then be saved for later use and implemented by the audio signal processor whenever the classifier indicates that the user (and the apparatus) is inside the car, whereas otherwise these specific tunings are not implemented. Similar content-dependent algorithm parameter set tunings could be determined for other environments and are then implemented as ‘typical’ parameter sets for the user (and then taken into use whenever a corresponding sound environment is identified by the analyser).

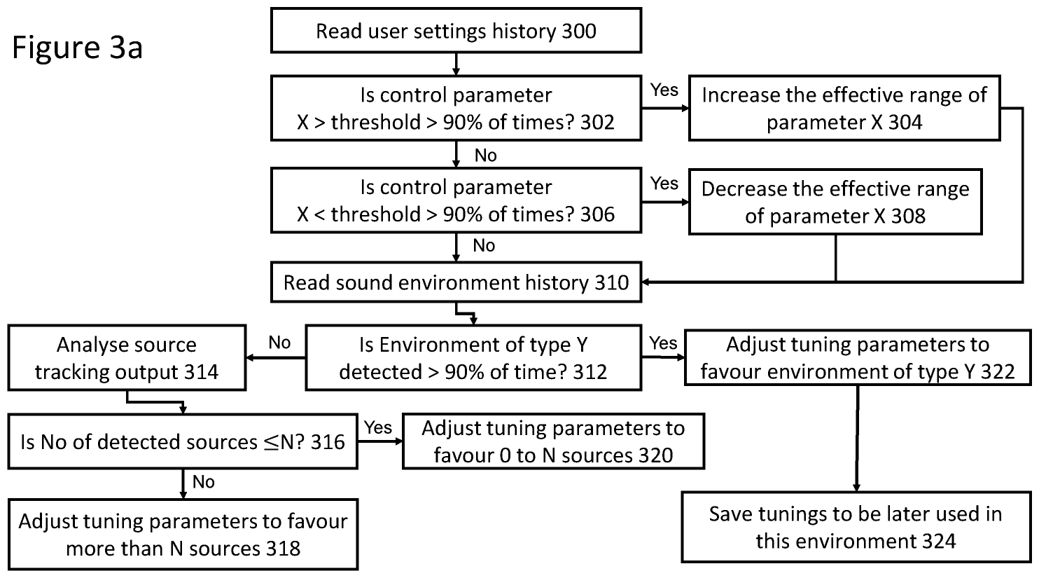

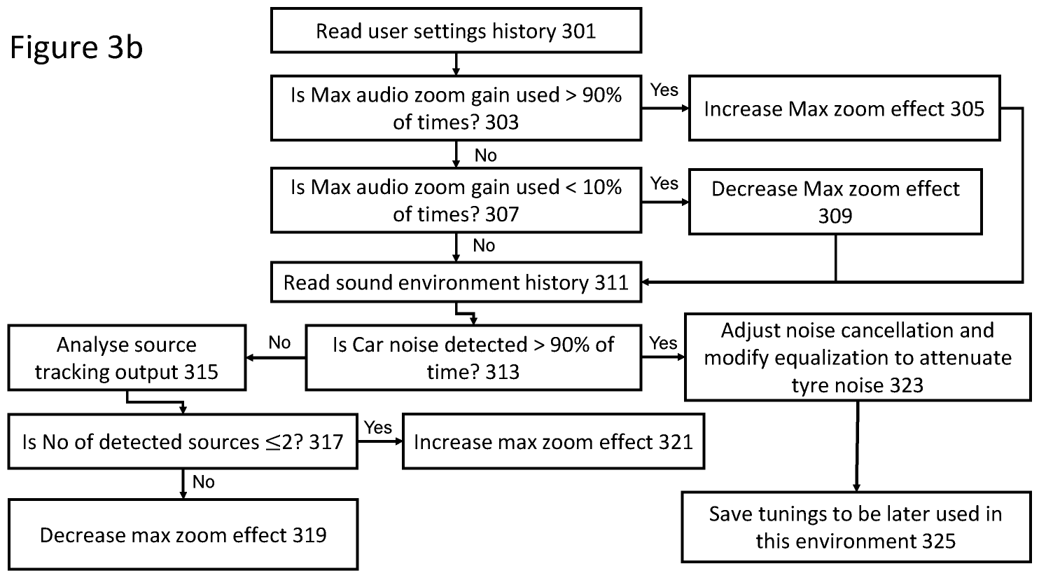

With respect to FIGS. 3a and 3b there are shown example flow diagrams of the operation of the example updater/storage 109 shown in FIGS. 1a and 2 is shown in further detail. In these examples both the user preference analysis and the spatial sound environment analysis is used to determine tuning parameters for the audio signal processing.

For example in FIG. 3a is shown a flow diagram of the tuning of parameter X, which can for example be a gain value for an audio zoom audio signal processing operation.

Thus, in some embodiments, the user settings history is read as shown in FIG. 3a by step 300.

Then the control parameter history is examined and checked to see if the control parameter X is greater than a threshold value for more than 90% of the time. The threshold check operation is shown in FIG. 3a by step 302.

Where the control parameter X is greater than a threshold value for more than 90% of the time then the next step is one increasing the effective range of parameter X as shown in FIG. 3a by step 304.

Where the control parameter X is not more than a threshold value for more than 90% of the time then the next step is one of checking if the control parameter X is less than the threshold value for more than 90% of the time as shown in FIG. 3a by step 306.

Following on where the control parameter X is less than the threshold value for more than 90% of the time then the next step is one decreasing the effective range of parameter X as shown in FIG. 3a by step 308.

Then the next operation is one of reading the sound environment history as shown in FIG. 3a by step 310.

A check is performed to determine whether the environment of type Y is detected more than 90% of the time as shown in FIG. 3a by step 312.

Where the environment of type Y is determined to occur >90% of the time then the tuning parameters are adjusted to favour the environment of type Y as shown by step 322 of FIG. 3a.

Then the tunings are saved to be used later when the environment is determined or detected as shown in FIG. 3a by step 324.

Furthermore where the environment of type Y is not detected more than 90% of the time then the source tracking output is analysed as shown in FIG. 3a by step 314.

Then there is a check operation determining whether the number of detected sources is less than or equal to a defined number N as shown in FIG. 3a by step 316.

Where the number of detected sources is less than or equal to a defined number N then the tuning parameters are adjusted to favour the number of sources being between 0 and N as shown in FIG. 3a by step 320.

Where the number of detected sources is more than a defined number N then the tuning parameters are adjusted to favour the number of sources being more than N sources as shown in FIG. 3a by step 318.

In other words FIG. 3a shows a flow chart to illustrate the principles of the overall learning process including both the user preferences analysis and the spatial sound environment analysis. Regarding user control analysis, a threshold value could be set for each user control related to a specific algorithm. The relative amount of control values set above and below this threshold value is then monitored, and the corresponding tuning parameters are modified accordingly. A percentage threshold is also set, e.g. 90%, to define when to modify the parameters and when to let them remain as is. Once the user settings are gone through, the sound environment history is gone through next. Specific tuning parameter sets could be tuned for some of the most common environment types, e.g. when a specific environment type is detected >90% of times during the specified time window. Otherwise, spatial sound source tracking could be applied to detect the amount of sound sources around the device, and a threshold value N could be set to modify the tuning parameters differently with respect to the number of sources.

Additionally FIG. 3b shows a flow diagram of the tuning a gain value for an audio zoom audio signal processing operation.

Thus in some embodiments the user settings history is read as shown in FIG. 3b by step 301.

Then the max audio zoom gain used history is examined and checked to see if the max audio zoom gain is used for more than 90% of the time. The threshold check operation is shown in FIG. 3b by step 303.

Where the max audio zoom gain is used for more than 90% of the time then the next step is one increasing the max zoom effect as shown in FIG. 3b by step 305.

Where the max audio zoom gain is not used for more than 90% of the time then the next step is one of checking if the max audio zoom gain used is less than 10% of the time as shown in FIG. 3b by step 307.

Following on where the max audio zoom gain used is less than 10% of the time then the next step is one decreasing the max zoom effect as shown in FIG. 3b by step 309.

Then the next operation is one of reading the sound environment history as shown in FIG. 3b by step 311.

A check is performed to determine whether car noise is detected >90% of the time as shown in FIG. 3b by step 313.

Where the car noise is detected >90% of the time then noise cancellation and equalization is adjusted or modified to attenuate tyre noise as shown in FIG. 3b by step 323.

Then the tunings are saved to be used later when the ‘car’ environment is determined or detected as shown in FIG. 3b by step 325.

Furthermore where the car noise is detected not to be more than 90% of the time then the source tracking output is analysed as shown in FIG. 3b by step 315.

Then there is a check operation determining whether the number of detected sources is less than or equal to a defined number 2 as shown in FIG. 3b by step 317.

Where the number of detected sources is less than or equal to the defined number 2 then the max zoom effect is increased as shown in FIG. 3b by step 321.

Where the number of detected sources is more than a defined number 2 then the tuning parameter are adjusted to decrease the max zoom effect as shown in FIG. 3b by step 319.

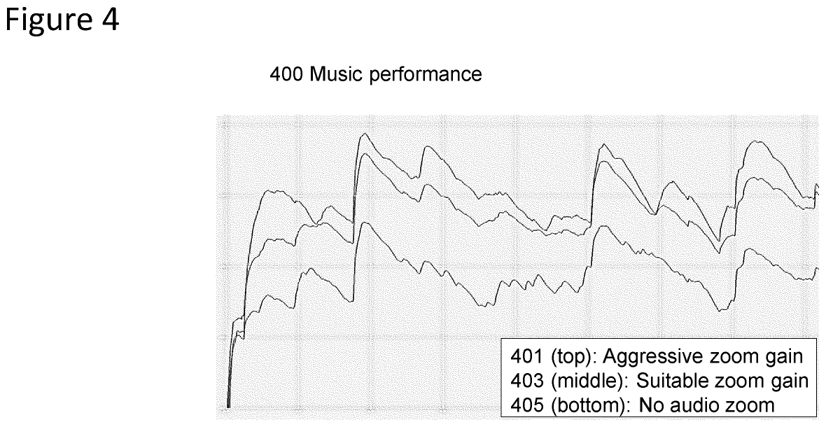

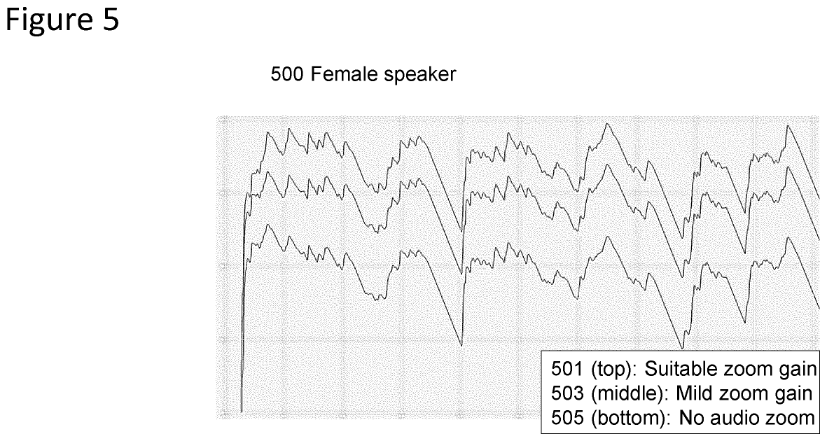

With respect to FIGS. 4 and 5 there is shown graphs demonstrating the technical effect of the tuning parameter learning process with the help of audio zooming algorithm. There are two audio capture situations demonstrated: a music performance (FIG. 4) and a female speaker (FIG. 5). In the first situation 400 music performance an aggressive audio zoom tuning 401 is first applied, which causes the audio signal gain level to rapidly jump up and down. This disturbs the listening experience, as music in general is more sensitive to aggressive signal processing than e.g. traffic noise signal. Hence, algorithm tuning is required, and after adaptively modifying the tuning parameters as described herein, suitable amount of zooming gain for music is gradually learned, enabling the signal gain level to remain smoother (as shown by the middle signal 403), while still achieving notable audio zooming effect when comparing the signal level to the original non-zoomed version (bottom signal 405).

In the second situation as shown in FIG. 5, female speaker 500, a unnecessarily mild audio zoom tuning is first applied (middle signal 503), such that the female speaker signal gain level is not amplified significantly compared to the original non-zoomed audio signal level (bottom signal 505). After tuning the algorithm, suitable zooming gain is again gradually learned, such that the speaker becomes more audible without causing yet any artefacts or rapid gain level jumps to the audio signal level (top signal 501).

In some embodiments since the classification results could be logged over time to learn typical sound environments where the device is being used, those could be helpful also in modifying the classifier itself, such that those classes that have been mainly present in the past would be gradually favoured and divided into sub-classes in the current and forthcoming classifications. For example, if the classifier output has been mainly speech in the past, it could be beneficial to change the active classifier model to a speech-specific audio classifier instead of the original one. This would allow a more detailed categorization of speech, such as speaker age, gender, language, emotions, etc. In practice the device could include several category-specific classifiers in addition to the default classifier, and the active one(s) could be indicated by modifying the classifier tuning parameters over time. Naturally, the default classifier needs to be running in the background and follow and update the main category classification history. If at a later stage speech is not the most common sound category anymore, the speech-specific classifier could be turned off and potentially be switched to another category-specific classifier.

Further regarding continuous adaptation of the algorithm tunings over time, it would be beneficial to receive some feedback from the user regarding the current algorithm behaviour. For example, opinions could be asked from the user about the current maximum audio zoom gain level or the amount of noise cancellation. The user could also tell their opinions without being asked via dedicated device/application settings. In some embodiments, indication could be given for the user about the updated tuning parameters, and the user could then either accept, reject or partly overwrite them. This could be thought of as a semi-automatic tuning adaptation.

In some further embodiments the algorithm tunings could be also dependent on the location and/or time of the device being used. For example, different languages could be processed differently due to varying pitches in the spoken languages. Naturally, the tunings could also adapt to the user own voice characteristics to enhance e.g. noise cancellation and speech enhancer tunings. Time-dependent adaptation could be utilized e.g. with audio classifier such that “speech” classification results would be favoured over “music” classifications during office hours at working days. This is because usually the sound environment at offices contains mainly speech instead of music.

In some embodiments at least one microphone audio signal can thus be obtained. Furthermore the at least one spatial sound environment parameter associated with the at least one microphone audio signal can be obtained. Additionally at least one monitored control setting is obtained. The monitored control setting can be determined by monitoring a plurality of control settings for an audio application based on monitoring. At least one audio application tuning parameter can be adjusted based on at least one of: the at least one spatial sound environment parameter; or the at least one monitored control setting. Furthermore the audio application can be controlled based on the adjusted at least one audio application tuning parameter, the application comprising an audio signal processing of the at least one microphone audio signal.

The obtaining of the at least one microphone audio signal can further comprise obtaining at least two microphone audio signals and obtaining at least one spatial sound environment parameter associated with the at least one microphone audio signal can comprise analysing the at least two microphone audio signals to determine the at least one spatial sound environment parameter.

The at least one spatial sound environment parameter can comprises at least one of: an environment spatial classification associated with the at least one microphone audio signal, the classification identifying a type of environment within which the at least one microphone audio signal is captured; a determined number of sound sources associated with the at least one microphone audio signal; at least one sound source direction with respect to the apparatus sources associated with the at least one microphone audio signal; at least one sound source location associated with the at least one microphone audio signal; at least one sound source position associated with the at least one microphone audio signal; a frequency response of at least one sound source associated with the at least one microphone audio signal; or a classification of at least one sound source associated with the at least one microphone audio signal.

Obtaining at least one monitored control setting can comprise monitoring at least one desired control parameter value for the audio application.

Controlling the audio application based on the at least one audio application tuning parameter can comprise controlling at least one audio application tuning parameter limit.

Adjusting at least one audio application tuning parameter based on at least one of: the at least one spatial sound environment parameter; or the at least one monitored control setting can comprise: storing the at least one of: the at least one spatial sound environment parameter; or the at least one monitored control setting for a defined analysis period; and determining the at least one audio application tuning parameter limit based on at least one of: the at least one spatial sound environment parameter; or the at least one monitored control setting, over the defined analysis period.

Determining the at least one audio application tuning parameter limit based on at least one of: the at least one spatial sound environment parameter; or the at least one monitored control setting, over the defined analysis period can comprise: increasing the at least one audio application tuning parameter limit maximum value when the at least one monitored control setting over the defined analysis period is greater than a threshold value for more than a defined portion of the defined analysis period; decreasing the at least one audio application tuning parameter limit maximum value when the at least one monitored control setting over the defined analysis period is less than the threshold value for more than a defined portion of the defined analysis period; and maintaining the at least one audio application tuning parameter limit maximum value otherwise.

The at least one audio application tuning parameter limit can comprise at least one of: a processing control parameter range; a processing control parameter value maximum; and a processing control parameter value minimum.

As used in this application, the term “circuitry” may refer to one or more or all of the following:
(a) hardware-only circuit implementations (such as implementation in only analogue and/or digital circuitry) and
(b) combinations of hardware circuits and software, such as (as applicable):
   (i) a combination of analogue and/or digital hardware circuit(s) with software/firmware and;
   (ii) any portions of hardware processor(s) with software (including digital signal processor(s), software, and memory(ies) that work together to cause an apparatus, such as a mobile phone or server, to perform various functions) and
   (iii) hardware circuit(s) and/or processor(s), such as microprocessor(s) or a portion of a microprocessor(s), that require software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device or computing or network device.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-24. (canceled)

25. A method, comprising:
obtaining at least one microphone audio signal;
obtaining at least one spatial sound environment parameter associated with the at least one microphone audio signal;
obtaining at least one monitored control setting, the monitored control setting determined with monitoring a plurality of control settings for an audio application;
adjusting at least one audio application tuning parameter based on at least one of: the at least one spatial sound environment parameter; or the at least one monitored control setting; and
controlling the audio application based on the at least one audio application tuning parameter, the application comprising an audio signal processing of the at least one microphone audio signal.

26. The method as claimed in claim 25, wherein obtaining at least one microphone audio signal further comprises obtaining at least two microphone audio signals.

27. The method as claimed in claim 26, wherein obtaining at least one spatial sound environment parameter comprises analysing the at least two microphone audio signals to determine the at least one spatial sound environment parameter.

28. The method as claimed in claim 25, wherein the at least one spatial sound environment parameter comprises at least one of:
an environment spatial classification associated with the at least one microphone audio signal, the classification identifying a type of environment within which the at least one microphone audio signal is captured;
a determined number of sound sources associated with the at least one microphone audio signal;
at least one sound source direction with respect to the apparatus sources associated with the at least one microphone audio signal;
at least one sound source location associated with the at least one microphone audio signal;
at least one sound source position associated with the at least one microphone audio signal;
a frequency response of at least one sound source associated with the at least one microphone audio signal; or
a classification of at least one sound source associated with the at least one microphone audio signal.

29. The method as claimed in claim 25, wherein obtaining the at least one monitored control setting comprises monitoring at least one desired control parameter value for the audio application.

30. The method as claimed in claim 25, wherein controlling the audio application comprises controlling at least one audio application tuning parameter limit.

31. The method as claimed in claim 30, wherein adjusting the at least one audio application tuning parameter comprises:
storing the at least one of: the at least one spatial sound environment parameter; or the at least one monitored control setting for a defined analysis period; and
determining an at least one audio application tuning parameter limit based on at least one of:
the at least one spatial sound environment parameter; or
the at least one monitored control setting, over the defined analysis period.

32. The method as claimed in claim 31, wherein determining the at least one audio application tuning parameter limit comprises one of:
increasing at least one audio application tuning parameter limit maximum value when the at least one monitored control setting over the defined analysis period is greater than a threshold value for more than a defined portion of the defined analysis period; or
decreasing at least one audio application tuning parameter limit maximum value when the at least one monitored control setting over the defined analysis period is less than the threshold value for more than a defined portion of the defined analysis period.

33. The method as claimed in claim 32, wherein determining the at least one audio application tuning parameter limit comprises maintaining at least one audio application tuning parameter limit maximum value otherwise.

34. The method as claimed in claim 25, wherein an at least one audio application tuning parameter limit comprises at least one of:
a processing control parameter range;
a processing control parameter value maximum; or
a processing control parameter value minimum.

35. An apparatus, comprising:
at least one processor and
at least one memory storing instructions that when executed with the at least one processor cause the apparatus at least to:
obtain at least one microphone audio signal;
obtain at least one spatial sound environment parameter associated with the at least one microphone audio signal;
obtain at least one monitored control setting, the monitored control setting determined with monitoring a plurality of control settings for an audio application;
adjust at least one audio application tuning parameter based on at least one of: the at least one spatial sound environment parameter; or the at least one monitored control setting; and
control the audio application based on the at least one audio application tuning parameter, the application comprising an audio signal processing of the at least one microphone audio signal.

36. The apparatus as claimed in claim 35, wherein the instructions, when executed with the at least one processor, cause the apparatus to obtain at least two microphone audio signals.

37. The apparatus as claimed in claim 36, wherein the instructions, when executed with the at least one processor, cause the apparatus to analyse the at least two microphone audio signals to determine the at least one spatial sound environment parameter.

38. The apparatus as claimed in claim 35, wherein the at least one spatial sound environment parameter comprises at least one of:
an environment spatial classification associated with the at least one microphone audio signal, the classification identifying a type of environment within which the at least one microphone audio signal is captured;
a determined number of sound sources associated with the at least one microphone audio signal;
at least one sound source direction with respect to the apparatus sources associated with the at least one microphone audio signal;
at least one sound source location associated with the at least one microphone audio signal;
at least one sound source position associated with the at least one microphone audio signal;
a frequency response of at least one sound source associated with the at least one microphone audio signal; or
a classification of at least one sound source associated with the at least one microphone audio signal.

39. The apparatus as claimed in claim 35, wherein the instructions, when executed with the at least one processor, cause the apparatus to monitor at least one desired control parameter value for the audio application.

40. The apparatus as claimed in claim 35, wherein the instructions, when executed with the at least one processor, cause the apparatus to control at least one audio application tuning parameter limit.

41. The apparatus as claimed in claim 40, wherein the instructions, when executed with the at least one processor, cause the apparatus to:
store the at least one of: the at least one spatial sound environment parameter; or the at least one monitored control setting for a defined analysis period; and
determine an at least one audio application tuning parameter limit based on at least one of:
the at least one spatial sound environment parameter; or
the at least one monitored control setting, over the defined analysis period.

42. The apparatus as claimed in claim 41, wherein the instructions, when executed with the at least one processor, cause the apparatus to one of:
increase at least one audio application tuning parameter limit maximum value when the at least one monitored control setting over the defined analysis period is greater than a threshold value for more than a defined portion of the defined analysis period; or
decrease at least one audio application tuning parameter limit maximum value when the at least one monitored control setting over the defined analysis period is less than the threshold value for more than a defined portion of the defined analysis period.

43. The apparatus as claimed in claim 42, wherein the instructions, when executed with the at least one processor, cause the apparatus to maintain at least one audio application tuning parameter limit maximum value otherwise.

44. The apparatus as claimed in claim 35 wherein an at least one audio application tuning parameter limit comprises at least one of:
a processing control parameter range;
a processing control parameter value maximum; or
a processing control parameter value minimum.
